(19) United States
(12) Patent Application Publication
(10) Pub. No.: US 2002/0095619 A1
(43) Pub. Date: Jul. 18, 2002

(54) Fault tolerant/redundant boot ROM reprogramming

(76) Inventor: Edward Thomas Marsh, Elgin, IL (US)

Correspondence Address: Richard L Sampson, Sampson & Associates PC, 50 Congress Street, Boston, MA, 02109, US

(21) Appl. No.: 09/761,951

(22) Filed: Jan. 17, 2001

(51) Int. Cl. G06F 11/14

(52) U.S. Cl. 714/23

(57) ABSTRACT

A system and method is provided that flashes updated boot code onto a redundant boot device. The updated boot sequence is then initiated. A determination is then made as to whether the boot sequence fails or properly terminates. In the event the boot sequence fails, then the system re-initiates booting using the old boot code. The determination may include starting a timer upon executing the initiating step, and stopping the timer when the boot sequence ends. If the timer times out before the timer is stopped, then the system considers the boot sequence to have failed, and then executes the re-initiation step.

### BACKGROUND INFORMATION

The number of devices having embedded processors to control their operation is proliferating. Such devices range from relatively simple digital watches, to Personal Digital Assistants (PDAs) such as the PALM PILOT®, various “smart” sensors used in manufacturing process control environments, and virtually any device designed to interface to the Internet (i.e., “net-enabled” devices). Such embedded processors typically use boot code (commonly referred to as a boot ROM), which includes startup files such as BIOS, which are stored in ‘firmware’, e.g., read-only memory (ROM), to enable them to be executed when the computer is initially turned on. The boot ROM completes various diagnostic and system set-up functions upon start-up. The boot ROM is generally stored within flash memory or within an EPROM (Electrically Programmable Read-Only Memory) or EEPROM (Electrically Erasable Programmable Read-Only Memory). Typically, changes made to the Operating System (OS) of such an embedded processor also require changes to be made to the boot ROM. Any such changes generally require reprogramming (i.e., reflashing) the ROM (e.g., EEPROM, etc.) Such reprogramming may be accomplished using specialized equipment at the manufacturing facility. As such, field upgrades to the OS are generally accomplished by replacement of hardware (e.g., replacement of the EEPROM, ROM or re-flashing the EEPROM, EPROM, etc.). However, in the event the target device is located in a remote location, e.g., aboard a satellite or other inaccessible location, such hardware swapping tends to be undesirably expensive. In these situations, it is desirable to effect the reprogramming remotely. If an embedded target is remotely located, then a reflashing (or reprogramming) scheme needs to be highly reliable. Such reliability is important because if the reflash fails, then the target will not be able to be reprogrammed, resulting in the loss of the target device unless the device can be physically retrieved.

The biggest risk in reprogramming boot code is the time required for the reflashing to be completed. There are a number of different failure modes that may occur during this time, such as the target becoming unstable due to power fluctuations, etc.

Thus, a need exists for a highly reliable boot ROM reprogramming system and method that addresses problems associated with the prior art.

### SUMMARY OF THE INVENTION

According to an embodiment of this invention, a method is provided for operating a target system having a random access memory and original boot code on first boot code storage media. The method includes loading replacement boot code onto replacement boot code storage media and initiating booting of the target using the replacement boot code. The method then automatically re-initiates booting of the target using the original boot code in the event the booting initiated by the initiation step fails.

Another embodiment of the present invention includes a method for reprogramming boot code in a target system having a random access memory and original boot code on first boot code storage media. The method includes loading replacement boot code onto replacement boot code storage media and initiating booting of the target using the replacement boot code. The method then automatically re-initiating booting of the target using the original boot code in the event the booting initiated by the initiation step fails.

A further embodiment of the present invention includes a board support package including a loading instruction to load replacement boot code onto replacement boot code storage media, and an initiating instruction to initiate booting of the target using the replacement boot code. The board support package also includes a re-initiating instruction to automatically reinitiate booting of the target using the original boot code in the event the booting initiated by the initiation instruction fails.

A still further embodiment of the present invention includes a method of configuring a target system to enable boot code reprogramming, the target system having a random access memory and original boot code in original boot code storage media. The method includes providing a load instruction to load replacement boot code onto replacement boot code storage media, and providing an initiate instruction to initiate booting of the target using the replacement boot code. The method also includes providing a re-initiate instruction to automatically re-initiate booting of the target using the original boot code in the event the booting initiated by the initiation instruction fails.

A yet further embodiment includes a system configured to enable boot code reprogramming. The system includes a loading instruction to load replacement boot code onto replacement boot code storage media, and an initiating instruction to initiate booting of the target using the replacement boot code. The system also includes a re-initiating instruction to automatically re-initiate booting of the target using original boot code in the event the booting initiated by the initiation instruction fails.

Another embodiment includes an article of manufacture for configuring a target system to enable boot code reprogramming. The article of manufacture includes a computer usable medium having a computer readable program code embodied therein. The computer usable medium includes computer readable program code for loading replacement boot code onto replacement boot code storage media, and computer readable program code for initiating booting of the target using the replacement boot code. Computer readable program code is also provided for automatically re-initiating booting of the target using original boot code in the event the booting initiated by the initiation code fails.

A further embodiment of the present invention includes computer readable program code for configuring a target system to enable boot code reprogramming. The computer readable program code includes computer readable program code for loading replacement boot code onto replacement boot code storage media, and computer readable program code for initiating booting of the target using the replacement boot code. Computer readable program code is also provided for automatically re-initiating booting of the target using original boot code in the event the booting initiated by the initiation code fails.

The above and other features and advantages of this invention will be more readily apparent from a reading of the following detailed description of various aspects of the invention taken in conjunction with the accompanying drawings.

### BRIEF DESCRIPTION OF THE DRAWINGS

FIG. 1 is a block diagrammatic view of a target system incorporating an embodiment of the present invention;

FIG. 2 is a flow chart representation of operation of a generalized embodiment of the present invention; and

FIGS. 3 and 4 are flow chart representations of operation of another embodiment of the present invention.

### DETAILED DESCRIPTION OF THE PREFERRED EMBODIMENTS

Referring to the figures set forth in the accompanying Drawings, the illustrative embodiments of the present invention will be described in detail hereinbelow. For clarity of exposition, like features shown in the accompanying Drawings shall be indicated with like reference numerals and similar features as shown in alternate embodiments in the Drawings shall be indicated with similar reference numerals.

Briefly described, embodiments of the present invention include a system/method for reflashing the boot ROM of a remote, embedded target in a redundant and fault-tolerant manner. These embodiments use two boot code storage devices instead of one for programming boot code on an embedded target.

Embodiments of the present invention include hardware and software aspects that may be varied depending upon the medium of communication used by the target, type of processor, and type of memory in which the boot ROM is stored. As used herein, the term “communication medium” or “communication media” include the method and/or devices used by the target to communicate with the outside world, including serial port, Ethernet, microwave, VMEbus open-standard bus system, etc.

Embodiments of the present invention may serve as an advantageous added feature to target systems to allow the OS of these targets to be conveniently remotely upgraded.

Embodiments of the present invention may be particularly useful in the telecommunications industry due to the need to have facilities in remote locations (e.g., remote antenna towers and satellites). These embodiments thus may simplify OS upgrades to reduce the time and expense associated therewith.

Before discussing details of the various embodiments of the present invention, a discussion of boot code and Board Diagnostics in Embedded Targets is useful.

Boot code in embedded targets allows various devices associated with the target and the OS to work together. Boot code contains tools (also referred to as diagnostics) that permit users obtain a status condition of the target. Some typical tools include:

Copy program to DRAM

Enable the memory-management unit (MMU)

Set general-purpose I/O pin input and output states

Set Communications

Set stack frame

Set heap

Writing commands and data to Flash (e.g., downloading through serial port 1)

Debugging LEDs

Debugging switches

Interrupt subsystem

Radiomodem port (e.g., serial port 3)

Internal LCD controller

Power monitoring (voltage and current)

Power switching

Keyboard and mouse interfacing

The user may have the option of placing the target into this diagnostic mode in many different ways. For instance, on a PC (i.e., a personal computer running a WINDOWS™ OS by MICROSOFT® Corporation) if the user presses (for example) F2, then the CMOS settings of the system may be viewed. (“CMOS” settings refer to various parameter values needed to boot PCs, such as the type of disks and the amount of memory, as well as the clock/calendar time.)

As mentioned hereinabove, boot code is often referred to as “firmware”. This is because the code that is executed by the Microprocessor resides physically burned or programmed into a storage device. In the early days of firmware, the code was programmed into ROMS (read-only memory devices), which could subsequently be erased by UV light. EPROMs, EEPROMs, Battery Backed Up RAM, and FLASH devices now offer the firmware designer additional options for programming boot code into an embedded target.

Once the target successfully boots, an operating system or program may be loaded that will perform specific functions or tasks. The operating system is often loaded into an embedded device in much the same way as boot code, i.e., as firmware.

Once firmware is programmed into an embedded target, changing or modifying it can be a complicated and expensive task. If not done properly, the target may be rendered useless. For example, when a user changes a value on a target, no old values are saved (i.e., the target cannot revert to previous values). Thus, if the modified value cannot boot correctly, the target will generally be inoperable.

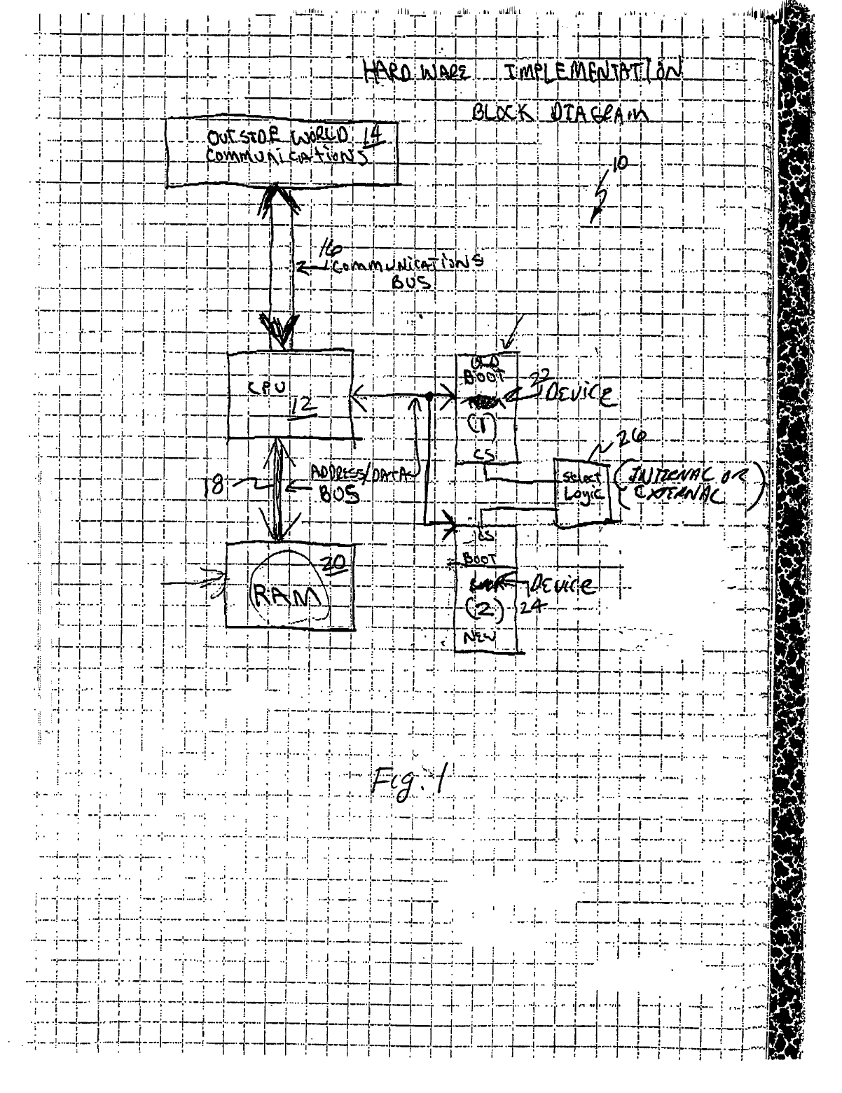

Referring now to the drawings in detail, the present invention will be described. Turning to FIG. 1, a hardware implementation of an embodiment of the present invention is shown as target device 10. As shown, this device 10 includes an embedded CPU 12 coupled to a communication module 14 by a communication bus 16. As mentioned hereinabove, communication module 14 may be substantially any component or module through which device 10 may communicate with the outside world. Examples of communication modules 14 include a serial port, modem port, Ethernet port, microwave port, PCI Bus, VME BUS, etc. CPU 12 is also coupled by an address/data bus 18 to Random Access Memory (RAM) 20 and to redundant first and second boot devices 22 and 24, respectively. As discussed hereinabove, boot devices 22 and 24 may be any suitable firmware storage devices, including ROMs (read-only memory devices), EPROMs, EEPROMs, Battery Backed Up RAM, and FLASH devices. Each of the boot devices 22 and 24 are coupled to a logic (e.g., select logic) module 26. Logic module 26 may be either an internal or external device, and may be implemented in hardware (such as in a conventional “chip select” of the CPU 12) or in software, depending on the particular CPU used. Logic module 26 serves to select which of the redundant first and second boot devices 22 and 24 are to be used by CPU 12 to boot-up device 10. The operation of logic module 26 is discussed in greater detail hereinbelow.

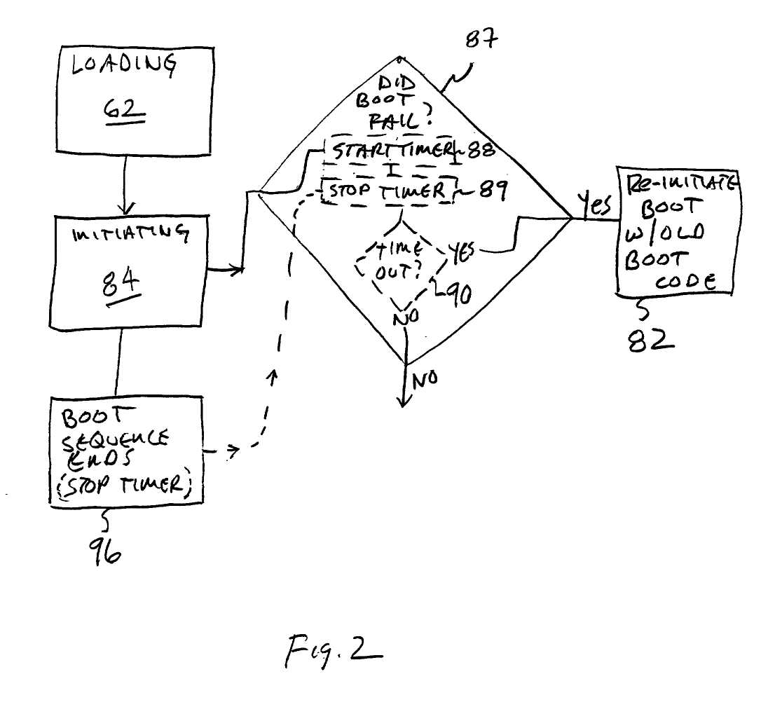

Turning now to FIG. 2, operation of a generalized embodiment of the present invention is described. As shown, the boot device 24 (FIG. 1) is loaded (e.g., flashed) 62 with the new boot code. The new boot sequence is then initiated 79. This embodiment then determines 87 whether the boot sequence initiated at 79 fails, or properly ends 96. In the event the boot sequence fails, then the system re-initiates 82 booting using the old boot code.

Optionally, as shown in phantom, the determining step 87 may include starting 88 a timer upon executing the initiating step 84, and stopping 89 the timer when the boot sequence ends 96. If the timer times out 90 before the timer is stopped 89, then the system considers the boot sequence to have failed, and then executes the re-initiation step 82.

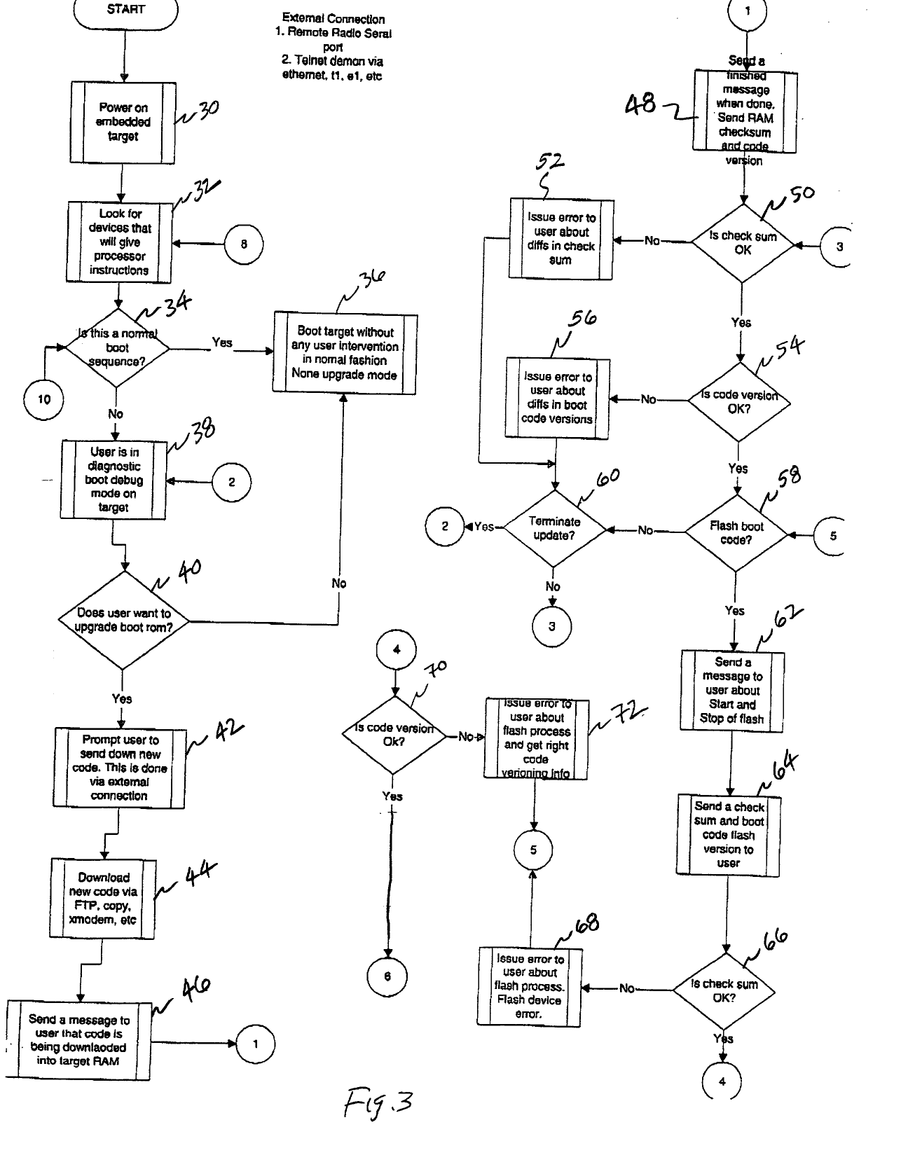

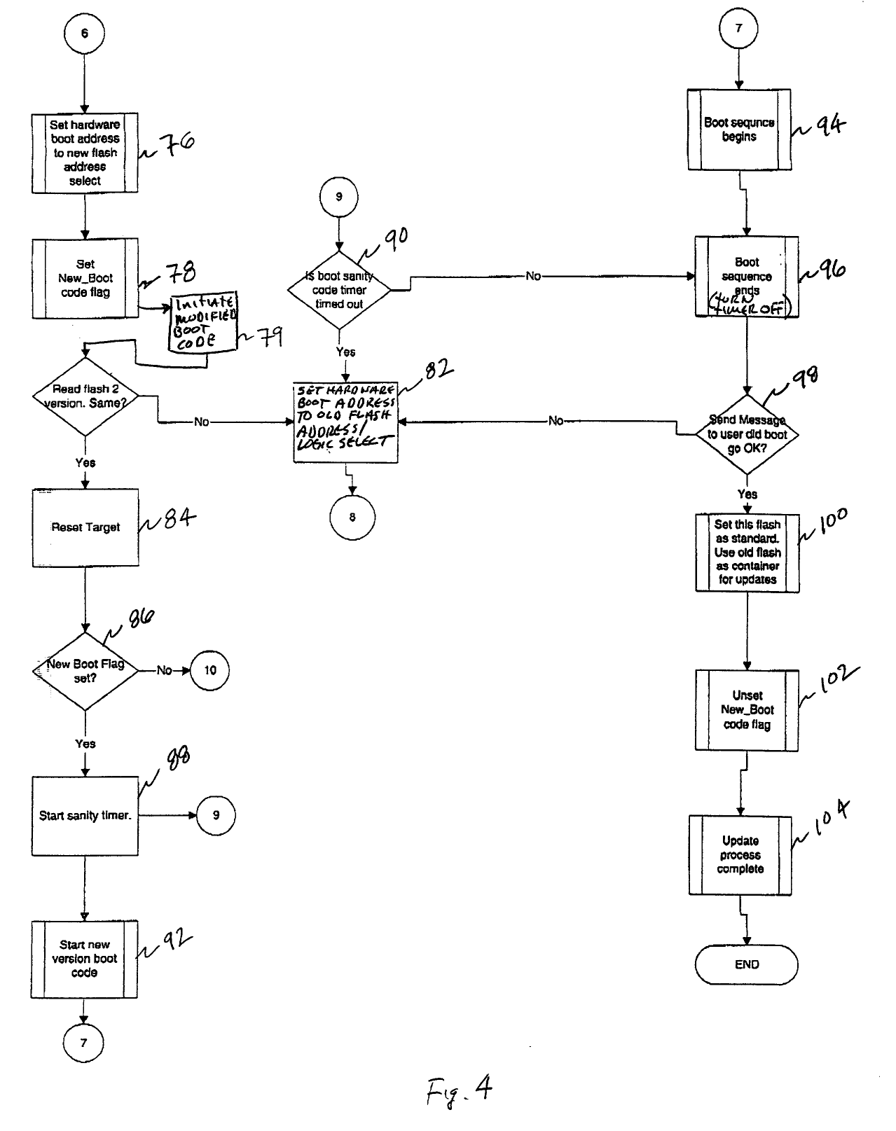

Turning now to FIGS. 3 & 4, operation of a more detailed embodiment of logic module 26 of the present invention is described. As shown, upon power-on 30 of the embedded target device 10, module 26 looks 32 for devices that may give instructions to CPU 12. Based upon the result of this looking step 32, e.g., whether any devices are found during boot-up that are providing instructions to CPU 12, module 26 then determines 34 whether a normal boot sequence is being implemented. If the boot sequence is normal, then target 10 is booted 36 in a normal manner without any user intervention. Alternatively, if no such devices are found, then logic module 26 determines 38 that the target 10 is in diagnostic boot debug mode. Once determination 38 is made, logic module asks 40 whether the user wishes to upgrade the boot logic. If the answer to this query 40 is NO, then execution branches to boot step 36. If the answer to query 40 is YES, then the user is prompted to send 42 new code using communications module 14 (FIG. 1). New boot code is then downloaded 44 into RAM 20 (FIG. 1) of target 10 using any suitable protocol, such as FTP, copy xmodem, etc. A message may optionally be sent 46 to the user that code is being downloaded. Upon completion of the download, a message may be sent 48, including a RAM checksum, and optionally, a code version indicator. Logic module 26 (FIG. 1) then queries 50 the sending machine as to whether the checksum is correct. If not, then a checksum error message is issued 52 to the user. If the checksum is correct, then the user may be queried 54 as to the accuracy of the code version. If the user responds that the code version is not accurate, then a code version error message is issued 56 to the user. If the code version is correct, then the user is queried 58 as to whether to flash (load) the new boot code in RAM 20 (FIG. 1) to the second boot device 24 (FIG. 1). If the answer to query 58 is NO, the program asks 60 whether the user wishes to terminate the update. If the answer to this query 60 is YES, then execution branches back to step 38. If the response to query 60 is NO, then execution branches back to step 50.

If the response to query 58 is YES, then the boot device 24 (FIG. 1) is flashed 62 with the new boot code, optionally with messages being sent to the user upon beginning and ending of this flashing step. A checksum and boot code flash version may then be sent 64 to the user, followed by a query 66 to the sending machine as to whether the checksum is correct. If the checksum is incorrect, then a flash process error message is issued 68 to the user. Execution then branches to step 58 to permit re-flashing or termination of the update.

If the response to query 66 is YES, (i.e., the checksum generated by step 64 is correct) then the system asks 70 whether the code version of the newly flashed boot code is correct. If the code version is incorrect, then a flash code version error message is issued 72 to the user, requesting correct code versioning information, followed by branching back to step 58 to permit re-flashing or termination of the update. If the code version is correct, then the hardware boot address may be set 76 to the new flash address select. A new boot code flag may also be set 78 in CPU 12 (FIG. 1), indicating to CPU 12 that a modified boot code has been installed. The new boot sequence may then be initiated 79.

The system may then read 80 the version of the new boot code, as flashed into boot device 24 (FIG. 1), and compare it to the version read previously (i.e., in step 54). If the compared versions are not the same, then the logic module 26 reverts 82 to the original boot code of first boot device 22 (FIG. 1). Execution then branches back to step 32.

Alternatively, if the versions compared in step 80 match, then the target CPU 12 (FIG. 1) may be reset 84, at which time the system then determines 86 whether this is the first execution of the new boot code by checking to see whether a New Boot Flag has been set. If the flag has not been set, execution branches back to step 34. Alternatively, if the flag has been set, then a timer may be set 88. The timer advantageously may be used to help ensure the new boot code (of device 24) properly boots the target. As shown at 90, if the timer times out before the new boot sequence has completed, execution is branched to step 82 to revert back to the original boot code (stored in boot device 22). Once the timer is started at 88, the new boot code is started 92, initiating the boot sequence 94. If the boot sequence ends 96 before the timer is timed out, then the system sends 98 a message to the user inquiring whether the target booted successfully. If the user responds to the negative, then execution branches back to step 82 for reverting to the original boot code. Alternatively, if the user responds in the affirmative, then logic module 26 sets 100 the second boot device 24 as the standard, and designates the first boot device for use in subsequent boot code updates. The system then unsets 102 the New Boot Code flag, so that the timer is not started 88 upon subsequent boots, to complete 104 the update process.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A method of operating a target system having a random access memory and original boot code on first boot code storage media, said method comprising:
(a) loading replacement boot code onto replacement boot code storage media;
(b) initiating booting of the target using the replacement boot code; and
(c) automatically re-initiating booting of the target using the original boot code in the event the booting initiated by the initiation step (b) fails.

2. The method of claim 1, wherein the automatically reinitiating step (c) comprises:
(d) starting a timer upon execution of the initiating step (b), the timer having a predetermined time-out period; and
(e) determining that the booting initiated in step (b) has failed if the timer times-out prior to completion of the booting initiated in step (b).

3. The method of claim 1, further comprising setting the replacement boot code as default boot code in the event the booting initiated in step (b) succeeds.

4. The method of claim 1, wherein the loading step (a) comprises:
(f) loading the replacement boot code into random access memory (RAM) in the target system;
(g) checking the replacement boot loaded into RAM for errors;
(h) loading the replacement boot code from RAM onto the replacement boot code storage media.

5. The method of claim 4, wherein the checking step (g) comprises checking a checksum.

6. The method of claim 5, wherein the checking step (g) further comprises checking a version indicator.

7. The method of claim 2, comprising:
(i) enabling the initiating step (b) to be repeated without invoking steps (d) and (e) in the event the booting initiated in step (b) succeeds.

8. The method of claim 7, wherein the enabling step (i) comprises:
(j) setting a flag prior to executing the initiating step (b);
(k) after the setting step (j) and before the starting step (d), determining whether the flag is set;
(l) executing the starting step (d) only if the flag is set;
(m) determining that the booting initiated in step (b) has succeeded if the timer does not time-out prior to completion of the booting initiated in step (b); and
(n) unsetting the flag if the booting initiated in step (b) has succeeded.

9. A method for reprogramming boot code in a target system having a random access memory and original boot code on first boot code storage media, said method comprising:
(a) loading replacement boot code onto replacement boot code storage media;
(b) initiating booting of the target using the replacement boot code; and
(c) automatically re-initiating booting of the target using the original boot code in the event the booting initiated by the initiation step (b) fails.

10. The method of claim 9, wherein the loading step (a) further comprises providing the replacement boot code storage media.

11. A board support package comprising:
a loading instruction to load replacement boot code onto replacement boot code storage media;
an initiating instruction to initiate booting of the target using the replacement boot code; and
a re-initiating instruction to automatically re-initiate booting of the target using the original boot code in the event the booting initiated by the initiation instruction fails.

12. The board support package of claim 11, further comprising:
a timer starting instruction to start a timer upon execution of the initiating instruction, the timer having a predetermined time-out period; and
a determining instruction to determine that the booting initiated by the initiating instruction has failed if the timer times-out.

13. A method of configuring a target system to enable boot code reprogramming, the target system having a random access memory and original boot code in original boot code storage media, said method comprising:
(a) providing a load instruction to load replacement boot code onto replacement boot code storage media;
(b) providing an initiate instruction to initiate booting of the target using the replacement boot code; and
(c) providing a re-initiate instruction to automatically re-initiate booting of the target using the original boot code in the event the booting initiated by the initiation instruction fails.

14. The method of claim 13, comprising:
(d) providing the replacement boot code storage media; and
(e) communicably coupling the replacement boot code storage media to the target system.

15. The method of claim 14, wherein the replacement boot code storage media is selected from the group consisting of an EEPROM, EPROM, Battery Backed Up RAM, ROM, FLASH device, and combinations thereof.

16. A system configured to enable boot code reprogramming, comprising:
a loading instruction to load replacement boot code onto replacement boot code storage media;
an initiating instruction to initiate booting of the target using the replacement boot code; and
a re-initiating instruction to automatically re-initiate booting of the target using original boot code in the event the booting initiated by the initiation instruction fails.

17. The system of claim 16, comprising the replacement boot code storage media.

18. The system of claim 17, wherein the replacement boot code storage media is selected from the group consisting of an EEPROM, EPROM, Battery Backed Up RAM, ROM, FLASH device, and combinations thereof.

19. An article of manufacture for configuring a target system to enable boot code reprogramming, the article of manufacture comprising:
a computer usable medium having a computer readable program code embodied therein, the computer usable medium having:
computer readable program code for loading replacement boot code onto replacement boot code storage media;
computer readable program code for initiating booting of the target using the replacement boot code; and
computer readable program code for automatically reinitiating booting of the target using original boot code in the event the booting initiated by the initiation code fails.

20. Computer readable program code for configuring a target system to enable boot code reprogramming, computer readable program code comprising:
computer readable program code for loading replacement boot code onto replacement boot code storage media;
computer readable program code for initiating booting of the target using the replacement boot code; and
computer readable program code for automatically reinitiating booting of the target using original boot code in the event the booting initiated by the initiation code fails.
